(19) United States
(12) Patent Application Publication
(10) Pub. No.: US 2014/0139556 A1
(43) Pub. Date: May 22, 2014

(54) APPARATUS AND METHOD FOR DISPLAYING SOFTWARE KEYBOARDS THEREOF

(71) Applicant: SHANGHAI POWERMO INFORMATION TECH CO., LTD., Shanghai (CN)

(72) Inventor: Qi Pan, Shanghai (CN)

(73) Assignee: SHANGHAI POWERMO INFORMATION TECH. CO. LTD., Shanghai (CN)

(21) Appl. No.: 13/684,234

(22) Filed: Nov. 22, 2012

(51) Int. Cl. G06F 3/0488

(52) U.S. Cl. CPC G06F 3/04886
USPC 345/660

(57) ABSTRACT

An apparatus and a method for displaying software keyboards are provided. The apparatus includes a touch screen and a control module. The touch screen is configured to display a primary software keyboard and configured to receive a user input of a user, wherein the primary software keyboard comprises a focus area, at least one adjacent area, and at least one periphery area. The focus area indicates a location for receiving the user input and is surrounded by the at least one adjacent area, and the at least one adjacent area are surrounded by the at least one periphery area. The control module is coupled to the touch screen for controlling the touch screen to enlarge the focus area and the at least one adjacent area while shrinking the at least one periphery area. By implementing such a method, users are allowed to type faster and more easily on the apparatus.

### BACKGROUND OF THE INVENTION

1. Field of the Invention

The present invention relates to an apparatus and a related method for displaying software keyboards, and more particularly, to an apparatus and a related method for displaying software keyboards in an intuitive way, thereby allowing a user to type faster and more easily.

2. Description of the Prior Art

Recently, an apparatus equipped with a touch screen has become more and more popular, and also such an apparatus is equipped with peripherals, such as a front-end camera, etc. Although the touch screen and the LCD of the apparatus become larger and larger, it's still not as convenient as traditional PCs to do typing-like user interactions. Furthermore, it's not so easy for a user to type by using a soft keyboard implementation. Therefore, how to provide and display a software keyboard in an intuitive way becomes an important topic in this field of art.

### SUMMARY OF THE INVENTION

It is one of the objectives of the present invention to provide an apparatus and a related method for displaying software keyboards to solve the abovementioned problems.

According to one aspect of the present invention, an apparatus for displaying software keyboards is provided. The apparatus includes a touch screen and a control module. The touch screen is configured to display a primary software keyboard and configured to receive a user input of a user, wherein the primary software keyboard comprises a focus area, at least one adjacent area, and at least one periphery area. The focus area indicates a location for receiving the user input and is surrounded by the at least one adjacent area, and the at least one adjacent area are surrounded by the at least one periphery area. The control module is coupled to the touch screen for controlling the touch screen to enlarge the focus area and the at least one adjacent area while shrinking the at least one periphery area.

According to another aspect of the present invention, a method for displaying software keyboards is provided. The method can be applied to an apparatus comprising a touch screen configured to receive a user input of a user. The method includes the following steps: displaying a primary software keyboard on the touch screen, the primary software keyboard comprises a focus area, at least one adjacent area, and at least one periphery area; wherein the focus area indicates a location for receiving the user input and is surrounded by the at least one adjacent area, and the at least one adjacent area are surrounded by the at least one periphery area; and controlling the touch screen to enlarge the focus area and the at least one adjacent area while shrinking the at least one periphery area.

By implementing such a method, users are allowed to type faster and more easily on the apparatus. Therefore, user interactions can be handled in a more intuitive way so as to avoid mistakenly typing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a conventional apparatus for displaying software keyboard according to the prior art.

FIG. 2 is a diagram showing an apparatus for displaying software keyboards according to a first embodiment of the present invention.

FIG. 3 is a diagram showing an apparatus for displaying software keyboards according to a second embodiment of the present invention.

FIG. 4 is a diagram showing an apparatus for displaying software keyboards according to a third embodiment of the present invention.

FIG. 5 is a diagram showing an apparatus for displaying software keyboards according to a fourth embodiment of the present invention.

FIG. 6 is a diagram showing an apparatus for displaying software keyboards according to a fifth embodiment of the present invention.

FIG. 7 is a flowchart illustrating a method for displaying software keyboards according to an exemplary embodiment of the present invention.

### DETAILED DESCRIPTION OF THE INVENTION

In the present invention, a typical user interaction for software keyboards is described. Here we define “a focus area”, “at least one adjacent area”, and “at least one periphery area” displayed on a primary software keyboard. However, regarding the algorithm for detecting the focus area is not described in the present invention. In one of the possible implementations, the location of a user's finger can be detected and recognized via infrared or sound Doppler effects when the user's finger is put in the air on the top of its intended input area.

Please refer to FIG. 1. FIG. 1 is a diagram showing a conventional apparatus 100 for displaying a software keyboard according to the prior art. As shown in FIG. 1, the conventional apparatus 100 includes a touch screen 110 and a control module (not shown). The touch screen 110 is configured to display a software keyboard 130, which may include a focus area 140, at least one adjacent area 150, and at least one periphery area 160. Be noted that the focus area 140 indicates a location for receiving the user input (such as, a finger) and is surrounded by the at least one adjacent area 150, and the at least one adjacent area 150 are surrounded by the at least one periphery area 160. As the gap between letters is quite small, it's easy to mistakenly touch the adjacent area of the intended letter when the user is typing words. For example, if the user desires to press the letter “G” (i.e., the so-called “focus area 140”), he may mistakenly touch the adjacent letter “F” or “H” (i.e., the so-called “at least one adjacent area 150”). Such a discursive typing way really bothers the users for a long time. Therefore, how to improve the software keyboard on the touch screen is indeed an extremely urgent issue for the users, especially when the users are typing words.

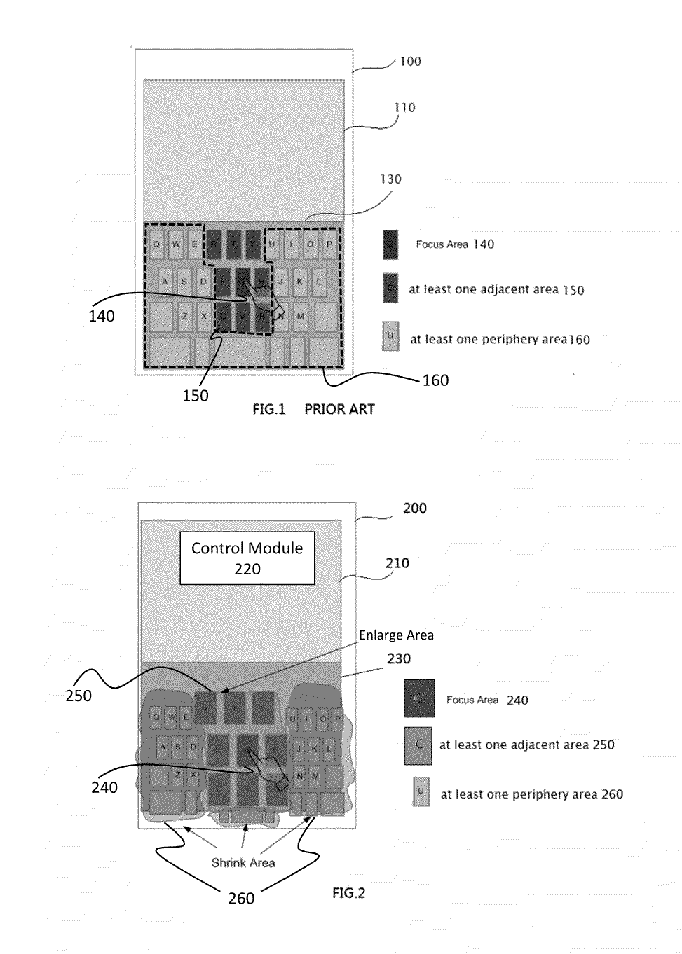

Please refer to FIG. 2. FIG. 2 is a diagram showing an apparatus 200 for displaying a software keyboard according to a first embodiment of the present invention. As shown in FIG. 2, the apparatus 200 may include a touch screen 210 and a control module 220. The control module 220 may be implemented by a CPU or a micro-processor, but is not limited to this only and can be controllers of other types. The touch screen 210 is configured to display a primary software keyboard 230 and configured to receive a user input of a user, such as a finger. Be noted that the primary software keyboard 230 may include a focus area 240, at least one adjacent area 250, and at least one periphery area 260. Herein the focus area 240 indicates a location for receiving the user input and is surrounded by the at least one adjacent area 250, and the at least one adjacent area 250 are surrounded by the at least one periphery area 260. The control module 220 is coupled to the touch screen 210. Please note that, the control module 220 is configured to control the touch screen 210 to enlarge the focus area 240 and the at least one adjacent area 250 while shrinking the at least one periphery area 260. In other words, the letter “G” (i.e., the so-called “focus area 240”) and these adjacent letters “R”, “T”, “Y”, “F”, “H”, “C”, “V”, and “B” are enlarged while the remaining periphery letters are shrunk. Since the letter that a user intended to type is enlarged, it's easier for the user to type the correct letter so as to avoid mistakenly typing.

What calls for special attention is that: in one embodiment, the touch screen 210 can be controlled to enlarge the focus area 240 and the at least one adjacent area 250 linearly while shrinking the at least one periphery area 260 linearly; however, in another embodiment, the focus area 240 and the at least one adjacent area 250 can be enlarged non-linearly while shrinking the at least one periphery area 260 non-linearly.

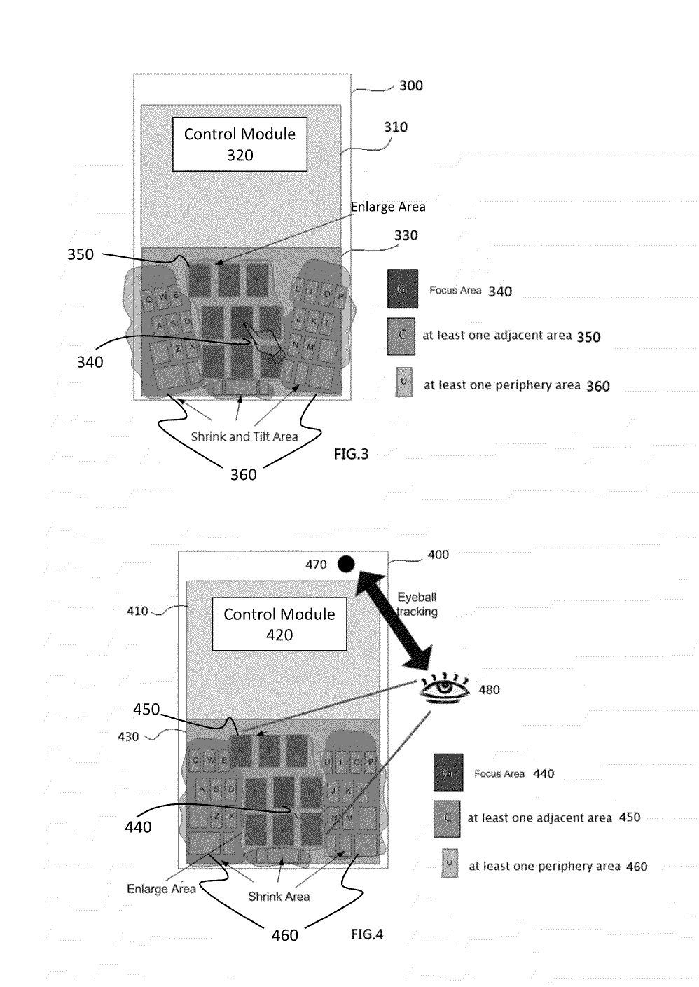

Please refer to FIG. 3. FIG. 3 is a diagram showing an apparatus 300 for displaying software keyboards according to a second embodiment of the present invention. The apparatus 300 shown in FIG. 3 is similar to the apparatus 200 shown in FIG. 2. The difference between them is that: a control module 320 of the apparatus 300 is configured to control the touch screen 310 to enlarge the focus area 340 and the at least one adjacent area 350 while shrinking and tilting the at least one periphery area 360. In such a way, the at least one periphery area 360 are tilted to various directions so that more space can be left to highlight the focus area 340 and the at least one adjacent area 350.

Please refer to FIG. 4. FIG. 4 is a diagram showing an apparatus 400 for displaying software keyboards according to a third embodiment of the present invention. As shown in FIG. 4, the apparatus 400 may include a touch screen 410, a control module 420, and a camera unit 470. The camera unit 470 is disposed near the touch screen 410, and is configured to track a movement of an eyeball 480 in order to generate a tracking information, such that the control module 420 is able to control the touch screen 410 to enlarge the focus area 440 and the at least one adjacent area 450 while shrinking the at least one periphery area 460 according to the tracking information, wherein the eyeball 480 is focused on the focus area 440. For example, if the eyeball 480 is focused on the letter “G” (the so-called “focus area 440”), the touch screen 410 can be controlled to automatically enlarge the letter “G” and its adjacent letters “R”, “T”, “Y”, “F”, “H”, “C”, “V”, and “B” according to the tracking information resulted from the eyeball 470; at the same time, the rest letters are shrunk.

Please refer to FIG. 5. FIG. 5 is a diagram showing an apparatus 500 for displaying software keyboards according to a fourth embodiment of the present invention. In this embodiment, the touch screen 510 is further configured to display a plurality of candidate letters of a plurality of forecast words after some letters of the forecast words are inputted via the touch screen 510. Furthermore, the control module 520 is further configured to control the touch screen 510 to highlight the plurality of candidate letters of the plurality of forecast words. In some situations, a user may need to continuously input several letters in a context, such as, to complete one word. For example, if the user have typed the letter “gr” and the algorithm indicates that the most possible letter for later typing is “e” for word “great” or “o” for word “group”, at this time, the letter of “E” and “0” can be highlighted on the touch screen 510 to let the user to find such letters easily and type quickly. The highlight method may include the following ways, but is not limited them only.
(1) Enlarge the plurality of candidate letters of the plurality of forecast words;
(2) Enlarge vacant spaces around the plurality of candidate letters of the plurality of forecast words;
(3) Highlight the plurality of candidate letters of the plurality of forecast words in various colors; and/or
(4) Highlight the plurality of candidate letters of the plurality of forecast words in various font effects.

In sub-diagram (5B) of FIG. 5, one of the implementations which simply enlarge the candidate letters (i.e., “E” and “0”) of the plurality of forecast words (i.e., “great” and “group”) with various colors is shown.

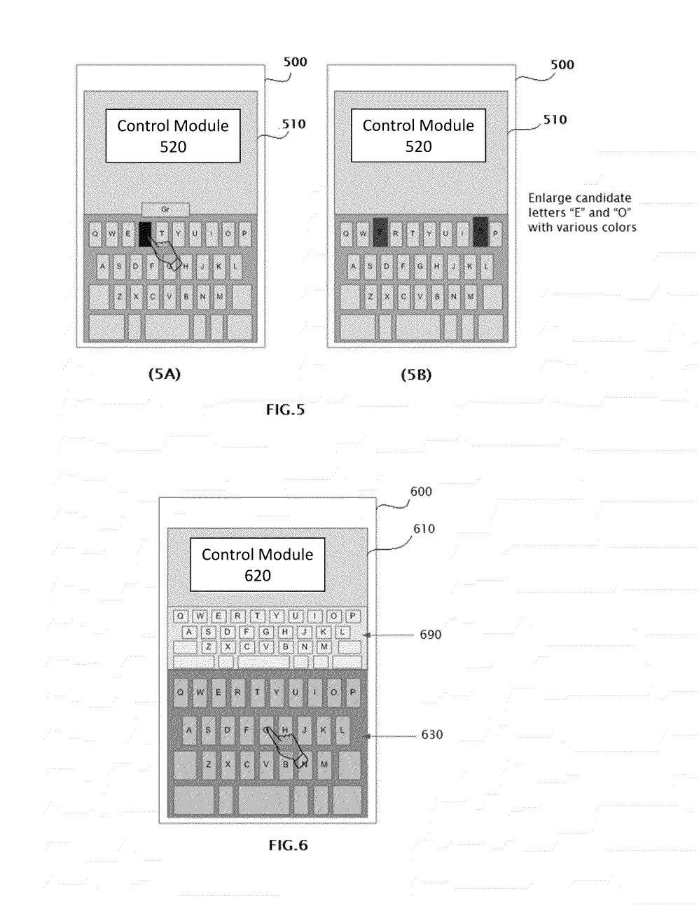

Please refer to FIG. 6. FIG. 6 is a diagram showing an apparatus 600 for displaying software keyboards according to a fifth embodiment of the present invention. In some situations, typing requires quick swiping-like operations between different letters, and the original input area may be sheltered by the user's finger when the user is typing, and thus which may make it difficult to find the next letter to type. FIG. 6 shows one implementation with a secondary software keyboard 690 defined. In this embodiment, the control module 620 is further configured to control the touch screen 610 to display a secondary software keyboard 690 close to the primary software keyboard 630. Be noted that: the secondary software keyboard 690 can have a minimized and same layout (or a minimized and similar layout which removes certain unnecessary letters) as the primary software keyboard 630 and provides a hit to the user about where he/she can find the next letter when interacting with the previous letter(s).

Those skilled in the art should appreciate that various modifications of the apparatuses in FIG. 2-FIG. 6 may be made without departing from the spirit of the present invention. For example, the apparatuses in FIG. 2-FIG. 6 can be arranged or combined randomly into a new varied embodiment. The abovementioned embodiments are presented merely for illustrating practicable designs of the present invention, and should not be limitations of the present invention.

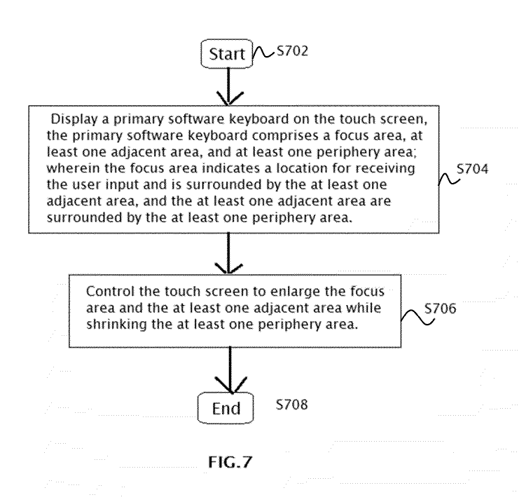

Please refer to FIG. 7. FIG. 7 is a flowchart illustrating a method for displaying a software keyboard according to an exemplary embodiment of the present invention. The method includes the following steps:
Step S702: Start.
Step S704: Display a primary software keyboard on the touch screen, the primary software keyboard comprises a focus area, at least one adjacent area, and at least one periphery area; wherein the focus area indicates a location for receiving the user input and is surrounded by the at least one adjacent area, and the at least one adjacent area are surrounded by the at least one periphery area.
Step S706: Control the touch screen to enlarge the focus area and the at least one adjacent area while shrinking the at least one periphery area.
Step S708: End.

Please note that, the abovementioned flowchart is merely an exemplary embodiment of the present invention, and in no way should be considered to be limitations of the scope of the present invention. The method can include other intermediate steps without departing from the spirit of the present invention. Those skilled in the art should observe that various modifications of the method may be made.

The abovementioned embodiments are presented merely for describing the present invention, and in no way should be considered to be limitations of the scope of the present invention. In summary, the present invention provides an apparatus and a method for displaying software keyboards in an intuitive way. In one embodiment, for example, the touch screen can be controlled to enlarge the focus area 240 and the at least one adjacent area 250 (linearly or non-linearly) while shrinking the at least one periphery area 260 (linearly or non-linearly). In another embodiment, the touch screen can be controlled to enlarge the focus area 340 and the at least one adjacent area 350 while shrinking and tilting the at least one periphery area 360. In still another embodiment, the touch screen can be controlled to display a plurality of candidate letters of a plurality of forecast words after some letters of the forecast words are inputted via the touch screen, and the control module can control the touch screen to highlight the plurality of candidate letters of the plurality of forecast words. By implementing such methods, users are allowed to type faster and more easily through the touch screen on the apparatus. Therefore, user interactions can be handled in a more intuitive way so as to avoid mistakenly typing.

Those skilled in the art will readily observe that numerous modifications and alterations of the device and method may be made while retaining the teachings of the invention.

What is claimed is:

1. An apparatus for displaying software keyboards, comprising:
a touch screen, configured to display a primary software keyboard and configured to receive a user input of a user, wherein the primary software keyboard comprises a focus area, at least one adjacent area, and at least one periphery area; wherein the focus area indicates a location for receiving the user input and is surrounded by the at least one adjacent area, and the at least one adjacent area are surrounded by the at least one periphery area; and
a control module, coupled to the touch screen, configured to control the touch screen to enlarge the focus area and the at least one adjacent area while shrinking the at least one periphery area.

2. The apparatus of claim 1, wherein the control module is configured to control the touch screen to enlarge the focus area and the at least one adjacent area linearly while shrinking the at least one periphery area linearly.

3. The apparatus of claim 1, wherein the control module is configured to control the touch screen to enlarge the focus area and the at least one adjacent area while shrinking and tilting the at least one periphery area.

4. The apparatus of claim 1, further comprising:
a camera unit, disposed near the touch screen, configured to track a movement of an eyeball in order to generate a tracking information, such that the control module is able to control the touch screen to enlarge the focus area and the at least one adjacent area while shrinking the at least one periphery area according to the tracking information, wherein the eyeball is focused on the focus area.

5. The apparatus of claim 1, wherein the touch screen is further configured to display a plurality of candidate letters of a plurality of forecast words after some letters of the forecast words are inputted via the touch screen, and the control module is further configured to control the touch screen to highlight the plurality of candidate letters of the plurality of forecast words.

6. The apparatus of claim 5, wherein the control module is configured to control the touch screen to enlarge the plurality of candidate letters of the plurality of forecast words or enlarge vacant spaces around the plurality of candidate letters of the plurality of forecast words.

7. The apparatus of claim 5, wherein the control module is configured to control the touch screen to highlight the plurality of candidate letters of the plurality of forecast words in various colors or in various font effects.

8. The apparatus of claim 1, wherein the control module is configured to control the touch screen to display a secondary software keyboard dose to the primary software keyboard, and the secondary software keyboard has a minimized and same layout as the primary software keyboard and provides a hit to the user.

9. The apparatus of claim 1, wherein the control module is configured to control the touch screen to display a secondary software keyboard dose to the primary software keyboard, and the secondary software keyboard has a minimized and similar layout as the primary software keyboard and provides a hit to the user.

10. A method for displaying software keyboards, applied to an apparatus comprising a touch screen configured to receive a user input of a user, the method comprising:
displaying a primary software keyboard on the touch screen, the primary software keyboard comprises a focus area, at least one adjacent area, and at least one periphery area; wherein the focus area indicates a location for receiving the user input and is surrounded by the at least one adjacent area, and the at least one adjacent area are surrounded by the at least one periphery area; and
controlling the touch screen to enlarge the focus area and the at least one adjacent area while shrinking the at least one periphery area.

11. The method of claim 10, wherein the step of controlling the touch screen to enlarge the focus area and the at least one adjacent area while shrinking the at least one periphery area comprises:
controlling the touch screen to enlarge the focus area and the at least one adjacent area linearly while shrinking the at least one periphery area linearly.

12. The method of claim 10, wherein the step of controlling the touch screen to enlarge the focus area and the at least one adjacent area while shrinking the at least one periphery area comprises:
controlling the touch screen to enlarge the focus area and the at least one adjacent area while shrinking and tilting the at least one periphery area.

13. The method of claim 10, wherein the apparatus further comprises a camera unit disposed near the touch screen, and the method further comprising:
using the camera unit to track a movement of an eyeball in order to generate a tracking information, wherein the eyeball is focused on the focus area; and
controlling the touch screen to enlarge the focus area and the at least one adjacent area while shrinking the at least one periphery area according to the tracking information.

14. The method of claim 10, further comprising:
displaying a plurality of candidate letters of a plurality of forecast words after some letters of the forecast words are inputted via the touch screen; and
controlling the touch screen to highlight the plurality of candidate letters of the plurality of forecast words.

15. The method of claim 14, wherein the step of controlling the touch screen to highlight the plurality of candidate letters of the plurality of forecast words comprises:
controlling the touch screen to enlarge the plurality of candidate letters of the plurality of forecast words or enlarge vacant spaces around the plurality of candidate letters of the plurality of forecast words.

16. The method of claim 14, wherein the step of controlling the touch screen to highlight the plurality of candidate letters of the plurality of forecast words comprises:
controlling the touch screen to highlight the plurality of candidate letters of the plurality of forecast words in various colors or in various font effects.

17. The method of claim 10, further comprising:
controlling the touch screen to display a secondary software keyboard dose to the primary software keyboard, wherein the secondary software keyboard has a minimized and same layout as the primary software keyboard and provides a hit to the user.

18. The method of claim 10, further comprising:
controlling the touch screen to display a secondary software keyboard close to the primary software keyboard, and the secondary software keyboard has a minimized and similar layout as the primary software keyboard and provides a hit to the user.
